(19) United States
(12) Patent Application Publication
(10) Pub. No.: US 2010/0100471 A1
(43) Pub. Date: Apr. 22, 2010

(54) ADAPTIVE BIDDING SCHEME FOR GUARANTEED DELIVERY CONTRACTS

(75) Inventors: Sai-Ming Li, Santa Clara, CA (US); R. Preston McAfee, San Marino, CA (US); Darshan V. Kantak, Pasadena, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/255,979

(22) Filed: Oct. 22, 2008

(51) Int. Cl. G06Q 40/00

(52) U.S. Cl. 705/37

(57) ABSTRACT

Disclosed are apparatus and methods for providing a bidding mechanism for guaranteed delivery contracts. In one embodiment, a method includes (i) providing a plurality of bid parameters that were updated based on a current delivery and/or a running cost per impression for such guaranteed delivery contract; (ii) if the advertisement impression is eligible to serve the guaranteed delivery contract, determining whether to submit a bid for the advertisement impression for the guaranteed delivery contract based on one or more of the bid parameters; and (iii) if it is determined that a bid is to be submitted for the guaranteed delivery contract, submitting a bid for the advertisement impression for the guaranteed delivery contract so that a bid amount is selected to be limited by one or more of the bid parameters.

### BACKGROUND OF THE INVENTION

The present invention is related to on-line advertising. It especially pertains to bidding type purchasing schemes for on-line advertisement inventory.

For many web portals and Internet Service Providers (ISPs), advertising is a major source of revenue. One form of advertising involves showing advertisers' advertisement banners on web sites that are being visited by users. For example, a preeminent portal such as Yahoo! displays advertisers' advertisements on one or more associated web sites that are viewed by users. In return, the advertisers pay a fee for each advertisement or a predefined number of advertisements viewed by web users. Contracts to show advertisements are normally negotiated and finalized several weeks or months before advertisements get delivered and are often expressed in terms of page views or impressions. The duration of contracts typically ranges from one day to multiple years.

A significant portion of advertising contracts take the form of guaranteed delivery bookings. A guaranteed delivery booking specifies an agreement between the advertisement seller or portal and an advertiser so as to guarantee delivery of specific inventory. For example, a guaranteed delivery booking specifies the price and the quantity of inventory, as well as the user target profile, to be delivered under the contract, and such information is specified in advance of the advertisement being delivered or displayed.

As their names imply, guaranteed delivery contract advertisers are guaranteed to receive all the inventory volume which is specified in the contract and at the price stated in the contract, while non-guaranteed delivery contracts do not specify a commitment in terms of delivery. The industrial practice is to serve all the guaranteed contracts first in order to minimize the chance of under-delivery. Contracts that are not guaranteed can then receive the remaining inventory, e.g., via a bidding process. However, this practice prevents the publisher from allocating certain valuable inventory to non-guaranteed delivery contract buyers who may be willing to pay a lot more than guaranteed delivery contract advertisers. Accordingly, it would be beneficial to provide improved mechanisms for allocating inventory.

### SUMMARY OF THE INVENTION

Accordingly, apparatus and methods for providing a bidding mechanism for guaranteed delivery contracts are disclosed. In one embodiment, a method includes (i) providing a plurality of bid parameters that were updated based on a current delivery and/or a running cost per impression for such guaranteed delivery contract; (ii) if the advertisement impression is eligible to serve the guaranteed delivery contract, determining whether to submit a bid for the advertisement impression for the guaranteed delivery contract based on one or more of the bid parameters; and (iii) if it is determined that a bid is to be submitted for the guaranteed delivery contract, submitting a bid for the advertisement impression for the guaranteed delivery contract so that a bid amount is selected to be limited by one or more of the bid parameters.

In a specific implementation, it is determined that a bid is to be submitted for the guaranteed delivery contract when a randomly selected number that is generated uniformly between 0.0 and 1.0 is less than a first bid parameter that corresponds to an adjustable probability value of submitting a bid for the guaranteed delivery contract. In another embodiment, the bid amount is selected as a random number that is generated uniformly to be between zero and a second bid parameter that corresponds to a maximum value of the bid for the guaranteed delivery contract.

In another specific embodiment, it is determined that a bid is to be submitted for the guaranteed delivery contract when a randomly selected number is less than a first bid parameter, α, that corresponds to an adjustable probability value of submitting a bid and wherein the bid amount is selected as a random number that is less than a second bid parameter, p*, that corresponds to a maximum value of the bid. In this embodiment, the method further includes after each period k of a campaign duration that is divided into a plurality of periods N for such guaranteed delivery contract, adjusting the first and second bid parameters based on a current delivery after such each period as compared to a delivery goal after such each period and based on a running cost per impression (CPI) after such period as compared to a maximum average CPI for the campaign. In a further aspect, the first parameter is increased and the second parameter is increased when the current delivery d(k) is less than the goal delivery g(k) and the running CPI is greater than the maximum CPI after such each period; the first parameter and the second parameter are both decreased when the current delivery is greater than the goal delivery and the running CPI is greater than the maximum CPI after such each period; the first parameter and the second parameter are both increased when the current delivery is less than the goal delivery and the running CPI is less than the maximum CPI after such each period; and the first parameter is decreased and the second parameter is increased when the current delivery is greater than the goal delivery and the running CPI is less than the maximum CPI after such each period.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of embodiments of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flowchart illustrating a procedure for bidding in a unified bidding exchange in accordance with one embodiment of the present invention.

FIG. 3 is a flowchart illustrating a procedure for a guaranteed delivery (GD) bidding procedure in accordance with a specific implementation of the present invention.

FIG. 4 is a diagrammatic illustration of a procedure for updating bid parameters in accordance with one embodiment of the present invention.

FIG. 5 illustrates an example computer system in which specific embodiments of the present invention may be implemented.

### DETAILED DESCRIPTION OF SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that they are not intended to limit the invention to these specific embodiments. On the contrary, such description is intended to cover alternatives, modifications, and equivalents as may be included within the spirit and scope of the invention as defined by the appended claims. In the following description, numerous specific details are set forth in order to provide a thorough understanding of embodiments of the present invention. Embodiments of the present invention may be practiced without some or all of these specific details. In other instances, well known process operations have not been described in detail in order not to unnecessarily obscure embodiments of the present invention.

Overview

In general, advertisement sellers and advertisers typically specify the product of transaction in terms of web property, position, one or more event specifications, and one or more specified user targeting parameters. An advertisement campaign duration and flight time at which time the campaign commences are also typically specified. The individual advertisement displays that are delivered to meet an advertiser's specified product may also be referred to as individual impressions. A web property may pertain to one or more web sites or a set of related web sites (e.g., a Finance web property). Sub-properties (e.g., a mutual fund web page from a Finance web property having multiple web pages) may also be specified. A property position may correspond to any suitable location with respect to displaying an advertisement in a particular property or sub-property. Examples of positions may correspond to particular relative positions or sections on a web page (e.g., top, bottom, or side). In some alternative embodiments, an advertiser may also specify one or more event specifications. An event specification, during which the corresponding advertisement is to be displayed, may pertain to a time or time duration (e.g., time of day or within a specified time-of-day window for displaying the advertisement) or one or more particular events (e.g., after occurrence of a user activity, such as performing a search in a Search property or sending an email).

A user targeting parameter may include any user characteristic that an advertisement may wish to target for advertisement purposes. User targeting parameters may include a geographical location or area, an age range, a gender, an income range, an educational level, one or more interest categories, one or more behavior characteristics, etc. Behavior characteristics may relate to tracked user activity (e.g., via user cookies), such as users that have visited specified sites, users that have visited specified sites more than a specified frequency, etc.

The advertisers and salespeople may negotiate either a guaranteed delivery (GD) contract or a non-guaranteed delivery (NGD) contract for a particular advertising product. As the name implies, a guaranteed delivery or GD contract is guaranteed to have all the specified inventory delivered for the GD contract, while the non-guaranteed or NGD contract is not guaranteed to have all the specified inventory delivered for such NGD contract. For instance, 100% of the specified inventory may be delivered for a GD contract, while only 90% of the specified inventory is delivered for the NGD contract. Typically, a GD contract will have a higher price for inventory, as compared to a NGD contract's price for the same inventory.

In specific embodiments, impressions are delivered to both GD and NGD contracts within a bidding exchange in which bids are submitted for individual, available impressions for both GD and NGD contracts. Such a “unified” bidding scheme that serves each impression to the contract that values it most, irrespective of whether the contract is GD or NGD, has the potential to unlock the value of inventory for both types of GD and NGD contracts. Such a unified exchange can be accomplished by having both types of contracts bidding for their desired inventory in an advertisement exchange setting, by way of example.

Certain embodiments of the present invention provide a simple adaptive scheme that can adjust for the uncertainty in market conditions to achieve a delivery outcome that meets a GD contract's goals. As publishers or sellers of advertisement inventory move towards a unified exchange marketplace for serving both GD and NGD contracts, it would be beneficial to provide a robust bidding scheme for GD contracts that enables such contracts to win sufficient quality inventory from other exchange participants. Bidding algorithms for GD contracts based on their goals and forecast of market conditions, such as the distribution of bids submitted by other participants, may result in poor performance when the forecasts are inaccurate. Accordingly, a practical scheme that enables bidding to react to uncertainties and changes in market conditions during delivery time would be beneficial.

In general, certain embodiments of the present invention include impression bidding mechanisms for GD contracts. Although certain embodiments are described herein in relation to particular targeting parameters or impression attributes (such as specified web properties and user demographics), any suitable advertisement scheme may be utilized by an advertiser for displaying a particular advertisement in any suitable manner to any suitable type of person in any suitable context.

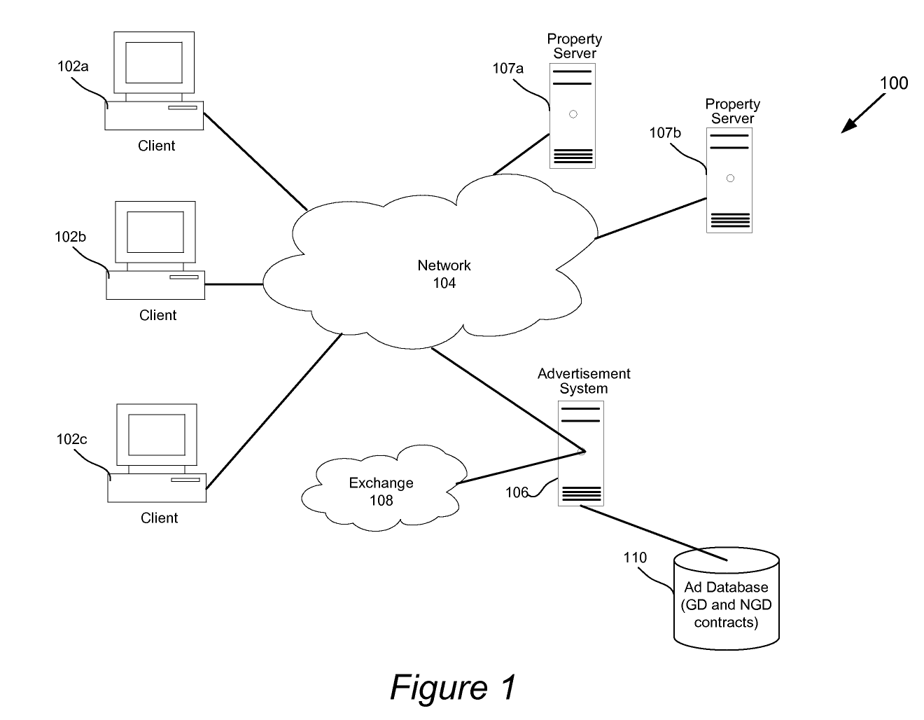

Prior to describing mechanisms for impression bidding for a GD contract, a computer network architecture will first be briefly described to provide an example context for practicing certain techniques of the present invention. FIG. 1 illustrates an example network segment 100 in which the present invention may be implemented in accordance with one embodiment of the present invention. As shown, a plurality of clients 102a˜102c may access one or more web property applications, for example, on property servers 107a and 107b via network 104 and/or access an advertisement service, for example, on advertisement system server 106. The advertisement system 106 (or servers) may have access to one or more advertisement database(s) 110 into which advertisement information, such as specified GD and NGD contract information, is retained.

The network may take any suitable form, such as a wide area network or Internet and/or one or more local area networks (LAN's). The network 104 may include any suitable number and type of devices, e.g., routers and switches, for forwarding web property requests from each client to each web property server and forwarding web results back to the requesting clients or for forwarding data between various servers.

The invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

Each web property application may implement any type of web service that is provided by a particular service provider (e.g., Yahoo! Inc. of Sunnyvale, Calif.), such as Yahoo! Answers, Yahoo! Autos, Yahoo! Finance, Yahoo! Games, Yahoo! Groups, Yahoo! HotJobs, Yahoo! Maps, Yahoo! Movies/TV, Yahoo! Music, Yahoo! Personals, Yahoo! Real Estate, Yahoo Shopping, Yahoo! Sports, Yahoo! Travel, Yahoo! Yellow Pages, Yahoo! Local, Yahoo! Search, Yahoo! Email, etc. Each property application may be utilized by a user (human or automated), e.g., on clients 102a˜102c. Additionally, each web property may correspond to any suitable number and type of web pages or other web objects (e.g., video, audio streams, photographs, etc.).

Advertisement salespeople who sell GD or NGD contracts to advertisers may interact with advertisement system 106 (e.g., via client 102a and through network 104). In one embodiment, a salesperson may issue a query to advertisement system 106 regarding a specified product or target. For example, the product may be specified for a particular web property, e.g., the Yahoo! email web property, a specified position for the advertisement to be displayed in such property, and particular demographics, e.g., California males who like sports and autos. The advertisement system 106 may then obtain a price for such specified product (e.g., from a pricing engine that is not shown), obtain inventory availability information (e.g., from 110), and return the available inventory information and price to the querying salesperson (e.g., to client 102 via network 104). The salesperson may then book a GD or NGD contract accordingly (e.g., with advertisement system 106 via network 104).

After GD or NGD contracts are booked by the advertisement system 106, the advertisement system 106 then operates to fill the booking (guaranteed contract) by providing the number of requested impressions (e.g., via a property server) at the negotiated price during the contract period. In one implementation, the advertisement system 106 interacts with an exchange 108 in which impressions are made available and bids are submitted for certain impressions for both the GD and NGD contracts. For instance, the bid exchange 108 executes bidding procedures for available impressions on behalf of both GD and NGD contracts to which such available impressions can serve.

Embodiments of the present invention may be employed with respect to any provider of one or more web property applications and/or advertisement system, and example providers include Yahoo! Inc., Google Inc., Microsoft Corp., etc. A plurality of web property applications, an advertisement system, and bid exchange, may be implemented on any number of servers although only one advertisement system 106, one exchange 108, and two web property servers 107a and 107b are illustrated for clarity and simplification of the description.

Bidding Embodiments

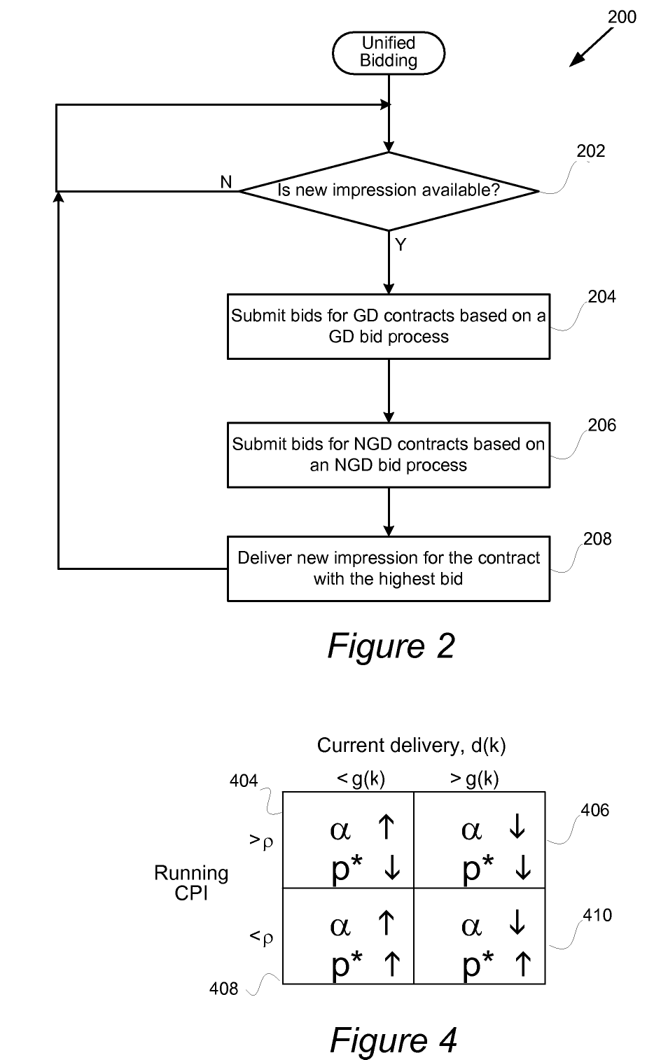

Regardless of the specific architecture, any suitable mechanism for bidding on an impression may be provided. FIG. 2 is a flowchart illustrating a procedure 200 for bidding in a unified bidding exchange in accordance with one embodiment of the present invention. Initially, it may be determined whether a new impression is available in operation 202. In not available, the bidding unified procedure 200 may continue to wait for an impression to be made available. For example, as users view a web object of a particular web property (e.g., opening a home page of the Finance property), an advertisement tag in such web object may be activated. For instance, each web page can include one or more advertisement tags for specifying an impression, e.g., specifying where an advertisement may be displayed in such web page. When the user opens a web page, each advertisement tag may be activated such that an advertisement request is sent to an advertisement server, e.g., advertisement server 106. The advertisement server may also notify the bidding exchange of available impressions. Alternatively, activation of a particular advertisement tag may cause a bidding exchange, e.g., exchange 108, to be notified of the available impression.

Once an impression is determined to be available, bids may then be submitted for guaranteed delivery (GD) contracts based on a GD bid process in operation 204. Bids may also be submitted for non-guaranteed delivery (NGD) contracts based on an NGD bid process in operation 206. The GD bid process typically differs from the NGD bid process so that the GD bid process results in the guaranteed inventory volume being delivered to the GD contracts, and the delivery is a reasonable representation of all the eligible traffic such that the GD contracts do not receive the lower quality inventory only.

Once bids are submitted for a particular impression, the particular impression may be delivered for the contract with the highest bid, regardless of whether such contract is a GD or NGD contract in operation 208. The unified bidding procedure 200 then ends for the particular impression. However, the bidding procedure 200 may then be repeated for each available impression.

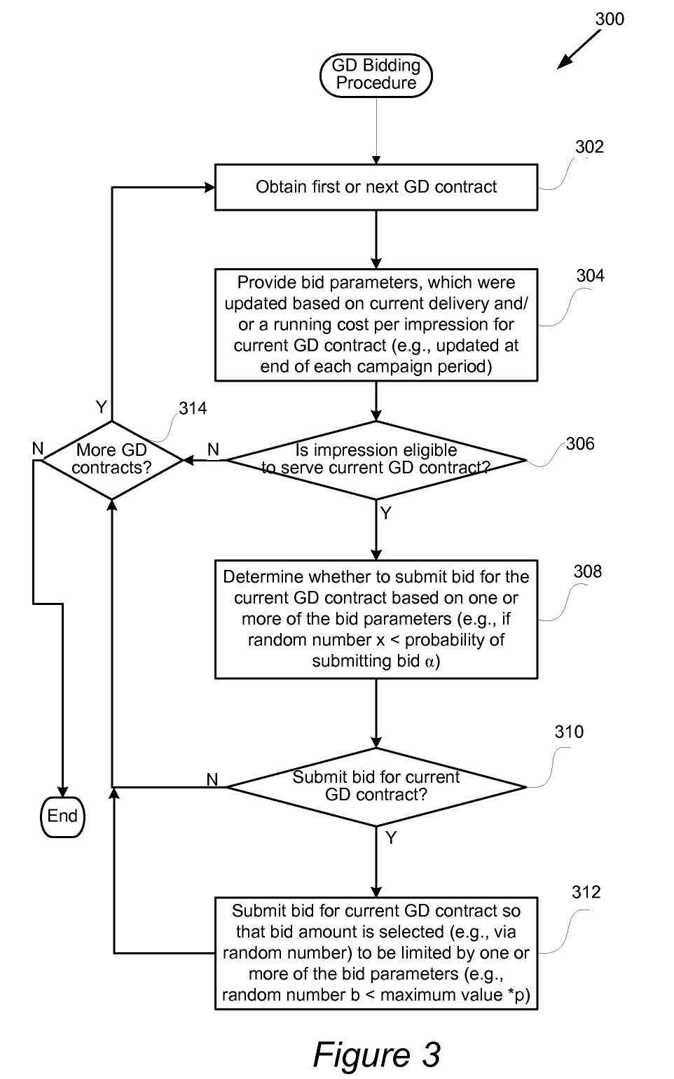

Any suitable technique may be utilized to implement an adaptive GD bidding process. FIG. 3 is a flowchart illustrating a procedure 300 for a guaranteed delivery (GD) bidding procedure in accordance with a specific implementation of the present invention. Initially, a first or next GD contact is obtained in operation 302. That is, the following GD bidding procedure may be implemented sequentially for each GD contract. Alternatively, bidding processes may be implemented concurrently on all GD contracts.

Bid parameters, which were updated based on a current delivery and/or a running cost per impression for the current GD contract (e.g., updated after each campaign period), may be provided in operation 304 as described further below. In a specific implementation for the current GD contract, a first bid parameter, α, corresponds to a probability of submitting the bid, while a second bid parameter, p*, corresponds to a maximum value for the bid. In this implementation, these bid parameters may be updated (e.g., based on a current delivery and a running cost per impression for the current GD contract) at the end of each campaign period as described further below.

It may also be determined whether the impression is eligible to serve the GD contract in operation 306. In a very simplified example, the available impression may pertain to a finance property and a male user who has income above $50,000 and resides in California. Such an impression can serve a GD contract for finance property users who have income above $50,000, as well as numerous other GD contracts for other products. Conversely, this impression cannot serve a GD contract for a mapping property or a GD contract for a Finance property and female users.

If the impression is not eligible for the current GD contract, it may be determined whether there are more GD contracts in operation 314. If there are no more GD contracts, the GD bid procedure may end for the particular impression. If there are more GD contracts, the next GD contract may then be obtained in operation 302 and it is again determined whether the impression can serve such next GD contract.

When the available impression is eligible to serve the current GD contract, it may then be determined whether to submit a bid for the current GD contract based on one or more of the bid parameters in operation 308. For example, it may be determined whether a random number X is less than the above described first bid parameter, α, which corresponds to a probability of submitting the bid for such current GD contract. In a specific implementation, a random number X between 0 and 1.0 is generated uniformly.

It may then be determined whether to submit the bid for the current GD contract in operation 310. In the above implementation example, if it is determined that X is less than the bid parameter, α, it may then be determined that a bid is to be submitted for the current GD contract. If a bid is to be submitted, a bid is submitted for the GD contract so that the bid amount is selected to be limited by one or more of the bid parameters in operation 312. For example, a random number is generated to be limited by the above described second bid parameter that corresponds to a maximum value for the bid, p* (e.g., between 0.0 and p*).

The GD bidding procedure may be repeated for all the GD contracts. For example, the following operations may be performed for each particular impression opportunity and GD contract:

(1) Check whether the particular impression opportunity is eligible to serve the particular GD contract. Proceed to operation 2 if yes. Otherwise, no bid will be submitted for this particular GD contract

(2) Draw a random number X from [0, 1] uniformly. Proceed to operation 3 if X<α. Otherwise no bid will be submitted for this particular GD contract

(3) Draw a random number b from [0, p*] uniformly. Submit b as the bid for this particular GD contract

The bid parameters may be periodically updated based on a current delivery and/or a running cost per impression using any suitable technique. That is, these bid parameters are adjusted on the fly as the campaign is running. FIG. 4 is a diagrammatic illustration of a procedure for updating bid parameters in accordance with one embodiment of the present invention. In this example, the α and p* bid parameters are updated based on two performance metrics: (i) current delivery with respect to goal and (ii) running cost per impression (CPI). The campaign duration can be divided into N periods of equal length, and the bidding parameters may be adjusted at the end of each period for capacity reasons. In other embodiments, the bidding parameters may periodically adjusted at any suitable frequency.

To facilitate the description, the following metrics may be defined with respect to a particular period, k, of a GD contract's campaign: ρ, g(k), c(k), and d(k). The ρ and g(k) metrics correspond to goals for the particular GD contract. The ρ metric corresponds to a maximum average CPI for the campaign, e.g., can be computed as the maximum amount to spend for the entire campaign divided by their delivery goal for the campaign or the total impressions that are specified to be delivered for the GD contract's campaign. For example, if the GD contract specifies $1 CPM (cost per thousand impressions) and 2,000,000 total impressions, the maximum amount to spend is $2,000 ($1 for each 1,000 impressions) and the maximum average CPI is $0.001 (or $2,000/2,000,000). The g(k) metric corresponds to the delivery goal at the end of period k, computed as (delivery goal for the campaign)×(k/N). In the above example, if the campaign is divided into 10 periods and the 1^{st} period has ended, the delivery goal for the end of the 1^{st} period, g(k), is 200,000 (2,000,000× 1/10)

The c(k) and d(k) metrics correspond to running metrics that change during the course of the campaign. The c(k) metric corresponds to the cost incurred in buying inventory from the exchange at the end of period k. The d(k) metric corresponds to the delivery (i.e., number of impressions delivered) to the campaign at the end of period k. In a specific example, a campaign is divided into quarters, and 500,000 impressions were sold for a total of $0.50 during the 1^{st} quarter and 1,000,000 were sold for $1.25 during the second quarter, the c(k) is $1.75 ($0.50+$1.25) and the d(k) is 1,500,000 (1,000,000+500,000) at the end of the 2^{nd} quarter.

Referring back to FIG. 4, the bid parameters are adjusted at the end of each period according to whether the running CPI is less than or greater than ρ and whether the current delivery, d(k), is less than or greater than the delivery goal, g(k). In this embodiment, a higher α means bidding more often and, hence, higher delivery, and a higher p* means a higher bid amount and, hence, higher quality but perhaps results in costlier impressions. By comparing the current delivery d(k) with the delivery goal g(k) and comparing the running CPI with the ρ, it can be determined which direction to adjust α and p* in order to achieve the campaign goal, while maximizing the quality of impressions received.

As shown in quadrant 404, when the current delivery d(k) is less than the goal delivery g(k) and the running CPI is greater than the maximum average CPI ρ, the probability of bidding parameter α is increased and the maximum bid value p* (and corresponding bid price) is decreased. As shown in quadrant 406, when the current delivery d(k) is greater than the goal delivery g(k) and the running CPI is greater than the maximum average CPI ρ, the probability of bidding parameter α and the maximum bid value p* (and corresponding bid price) are both decreased. Conversely as shown in quadrant 408, when the current delivery d(k) is less than the goal delivery g(k) and the running CPI is less than the maximum average CPI ρ, the probability of bidding parameter α and the maximum bid value p* (and corresponding bid price) are both decreased. As shown in quadrant 410, when the current delivery d(k) is greater than the goal delivery g(k) and the running CPI is less than the maximum average CPI ρ, the probability of bidding parameter α is decreased and the maximum bid value p* (and corresponding bid price) is increased.

In order to ensure that the parameters α and p* remain in some logical region under this adaptive scheme, bounds may be enforced. The limits for such adaptive algorithm may take the following form:

$$α ( k + 1 ) = max ( min ( α ( k ) + β ( g ( k ) - d ( k ) ) , 1 ) , 0 )$$

$${p}^{*} ( k + 1 ) = min ( max ( {p}^{*} ( k ) - γ ( \frac{c ( k )}{d ( k )} - ρ ) , ρ ) , {\overline{ρ}}^{*} )$$

where β and γ are small positive numbers that represent the adaptation rates, and p̅* is the maximum value for p*.

Besides having an affect on the price of inventory won, p* may also have an impact on the volume of delivery since a higher p* can mean that more auctions will be won and more costs incurred. Hence, current delivery d(k) and incurred cost c(k) may also be reasonably used to further adjust p* as well. One possible scheme takes the following form:

$${p}^{*} ( k + 1 ) = min ( max ( {p}^{*} ( k ) - γ ( \frac{c ( k )}{d ( k )} - ρ ) - η ( g ( k ) - d ( k ) ) , ρ ) , {\overline{p}}^{*} )$$

where η is a small positive number.

Certain embodiments of the present invention may enable a GD contract bidding agent to adapt to a changing competitive environment and supply conditions to ensure that the delivery goal is met. Additionally, an adaptive scheme may also help to smooth out the delivery of impressions over the campaign duration, which can be an important goal for online advertisers.

Computer System

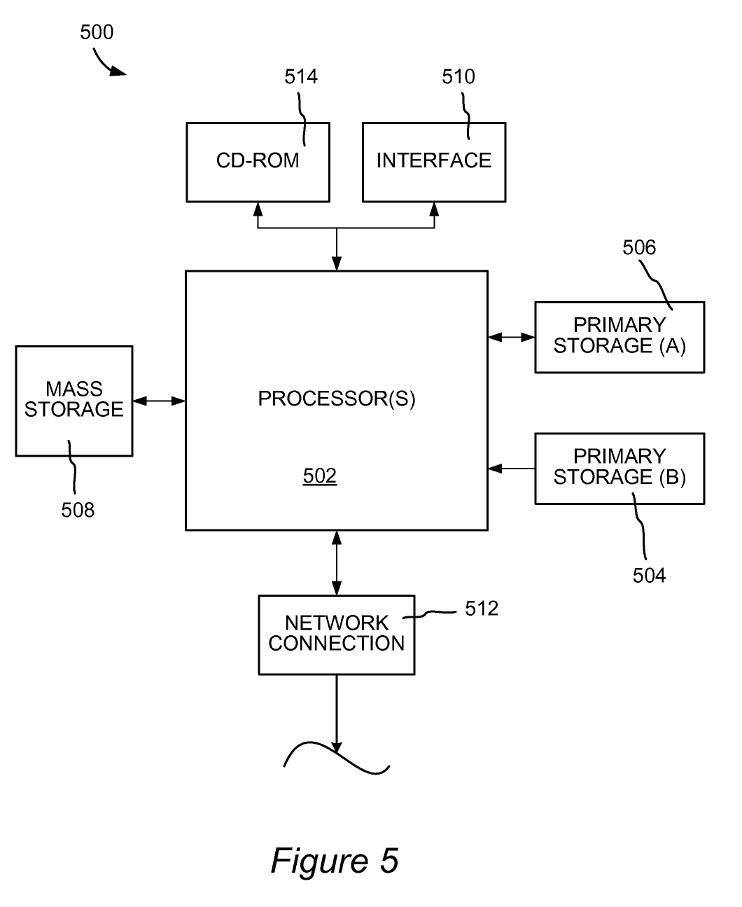

FIG. 5 illustrates a typical computer system that, when appropriately configured or designed, can serve as an advertisement GD bidding system. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers and microprocessors such as programmable devices (e.g., CPLDs and FPGAs) and unprogrammable devices such as gate array ASICs or general-purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described herein. A mass storage device 508 is also coupled bi-directionally to CPU 502 and provides additional data storage capacity and may include any of the computer-readable media described herein. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 is also coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications network using an external connection as shown generally at 512. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store bid parameters, current delivery data, running CPI values, GD and NGD contract information, goal delivery data, maximum average CPI values, costs incurred, random numbers X and b, available impression attributes, booking prices, booking flight dates, booking durations, number of impressions for each booking, etc.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method for bidding for an advertisement impression for a guaranteed delivery contract wherein the advertisement impression corresponds to a plurality of user target attributes for which an on-line advertisement can be displayed, the method comprising:
providing a plurality of bid parameters that were updated based on a current delivery and/or a running cost per impression for such guaranteed delivery contract;
if the advertisement impression is eligible to serve the guaranteed delivery contract, determining whether to submit a bid for the advertisement impression for the guaranteed delivery contract based on one or more of the bid parameters; and
if it is determined that a bid is to be submitted for the guaranteed delivery contract, submitting a bid for the advertisement impression for the guaranteed delivery contract so that a bid amount is selected to be limited by one or more of the bid parameters.

2. The method of claim 1, wherein it is determined that a bid is to be submitted for the guaranteed delivery contract when a randomly selected number that is generated uniformly between 0.0 and 1.0 is less than a first bid parameter that corresponds to an adjustable probability value of submitting a bid for the guaranteed delivery contract.

3. The method of claim 1, wherein the bid amount is selected as a random number that is generated uniformly to be between zero and a second bid parameter that corresponds to a maximum value of the bid for the guaranteed delivery contract.

4. The method of claim 1, wherein it is determined that a bid is to be submitted for the guaranteed delivery contract when a randomly selected number is less than a first bid parameter, α, that corresponds to an adjustable probability value of submitting a bid and wherein the bid amount is selected as a random number that is less than a second bid parameter, p*, that corresponds to a maximum value of the bid, the method further comprising:
after each period k of a campaign duration that is divided into a plurality of periods N for such guaranteed delivery contract, adjusting the first and second bid parameters based on a current delivery after such each period as compared to a delivery goal after such each period and based on a running cost per impression (CPI) after such period as compared to a maximum average CPI for the campaign.

5. The method of claim 4, wherein:
the first parameter is increased and the second parameter is increased when the current delivery d(k) is less than the goal delivery g(k) and the running CPI is greater than the maximum CPI after such each period;
the first parameter and the second parameter are both decreased when the current delivery is greater than the goal delivery and the running CPI is greater than the maximum CPI after such each period;
the first parameter and the second parameter are both increased when the current delivery is less than the goal delivery and the running CPI is less than the maximum CPI after such each period; and
the first parameter is decreased and the second parameter is increased when the current delivery is greater than the goal delivery and the running CPI is less than the maximum CPI after such each period.

6. The method of claim 4, wherein the first and second parameters are limited by the following bounds:
$$α ( k + 1 ) = max ( min ( α ( k ) + β ( g ( k ) - d ( k ) ) , 1 ) , 0 )$$
$${p}^{*} ( k + 1 ) = min ( max ( {p}^{*} ( k ) - γ ( \frac{c ( k )}{d ( k )} - ρ ) , ρ ) , {\overline{ρ}}^{*} )$$
where c(k) is the cost incurred at the end of period k, d(k) is the current delivery at the end of period k, α(k) is the first parameter at the end of period k, p*(k) is the second parameter at the end of period k, β and γ are small positive numbers that represent the adaptation rates, and p̅* is the maximum value for p*.

7. The method of claim 6, wherein the second parameter is further adjusted according to:
$${p}^{*} ( k + 1 ) = min ( max ( {p}^{*} ( k ) - γ ( \frac{c ( k )}{d ( k )} - ρ ) - η ( g ( k ) - d ( k ) ) , ρ ) , {\overline{p}}^{*} )$$
where η is a small positive number.

8. An apparatus for bidding for an advertisement impression for a guaranteed delivery contract wherein the advertisement impression corresponds to a plurality of user target attributes for which an on-line advertisement can be displayed, the apparatus comprising at least a processor and a memory, wherein the processor and/or memory are configured to perform the following operations:
providing a plurality of bid parameters that were updated based on a current delivery and/or a running cost per impression for such guaranteed delivery contract;
if the advertisement impression is eligible to serve the guaranteed delivery contract, determining whether to submit a bid for the advertisement impression for the guaranteed delivery contract based on one or more of the bid parameters; and
if it is determined that a bid is to be submitted for the guaranteed delivery contract, submitting a bid for the advertisement impression for the guaranteed delivery contract so that a bid amount is selected to be limited by one or more of the bid parameters.

9. The apparatus of claim 8, wherein it is determined that a bid is to be submitted for the guaranteed delivery contract when a randomly selected number that is generated uniformly between 0.0 and 1.0 is less than a first bid parameter that corresponds to an adjustable probability value of submitting a bid for the guaranteed delivery contract.

10. The apparatus of claim 8, wherein the bid amount is selected as a random number that is generated uniformly to be between zero and a second bid parameter that corresponds to a maximum value of the bid for the guaranteed delivery contract.

11. The apparatus of claim 8, wherein it is determined that a bid is to be submitted for the guaranteed delivery contract when a randomly selected number is less than a first bid parameter, α, that corresponds to an adjustable probability value of submitting a bid and wherein the bid amount is selected as a random number that is less than a second bid parameter, p*, that corresponds to a maximum value of the bid, wherein the processor and/or memory are further configured to perform the following operation:
after each period k of a campaign duration that is divided into a plurality of periods N for such guaranteed delivery contract, adjusting the first and second bid parameters based on a current delivery after such each period as compared to a delivery goal after such each period and based on a running cost per impression (CPI) after such period as compared to a maximum average CPI for the campaign.

12. The apparatus of claim 11, wherein:
the first parameter is increased and the second parameter is increased when the current delivery d(k) is less than the goal delivery g(k) and the running CPI is greater than the maximum CPI after such each period;
the first parameter and the second parameter are both decreased when the current delivery is greater than the goal delivery and the running CPI is greater than the maximum CPI after such each period;
the first parameter and the second parameter are both increased when the current delivery is less than the goal delivery and the running CPI is less than the maximum CPI after such each period; and
the first parameter is decreased and the second parameter is increased when the current delivery is greater than the goal delivery and the running CPI is less than the maximum CPI after such each period.

13. The apparatus of claim 11, wherein the first and second parameters are limited by the following bounds:
$$α ( k + 1 ) = max ( min ( α ( k ) + β ( g ( k ) - d ( k ) ) , 1 ) , 0 )$$
$${p}^{*} ( k + 1 ) = min ( max ( {p}^{*} ( k ) - γ ( \frac{c ( k )}{d ( k )} - ρ ) , ρ ) , {\overline{ρ}}^{*} )$$
where c(k) is the cost incurred at the end of period k, d(k) is the current delivery at the end of period k, α(k) is the first parameter at the end of period k, p*(k) is the second parameter at the end of period k, β and γ are small positive numbers that represent the adaptation rates, and p̅* is the maximum value for p*.

14. The apparatus of claim 13, wherein the second parameter is further adjusted according to:
$${p}^{*} ( k + 1 ) = min ( max ( {p}^{*} ( k ) - γ ( \frac{c ( k )}{d ( k )} - ρ ) - η ( g ( k ) - d ( k ) ) , ρ ) , {\overline{p}}^{*} )$$
where η is a small positive number.

15. At least one computer readable storage medium having computer program instructions stored thereon for bidding for an advertisement impression for a guaranteed delivery contract wherein the advertisement impression corresponds to a plurality of user target attributes for which an on-line advertisement can be displayed and that are arranged to perform the following operations:
providing a plurality of bid parameters that were updated based on a current delivery and/or a running cost per impression for such guaranteed delivery contract;
if the advertisement impression is eligible to serve the guaranteed delivery contract, determining whether to submit a bid for the advertisement impression for the guaranteed delivery contract based on one or more of the bid parameters; and
if it is determined that a bid is to be submitted for the guaranteed delivery contract, submitting a bid for the advertisement impression for the guaranteed delivery contract so that a bid amount is selected to be limited by one or more of the bid parameters.

16. The at least one computer readable storage medium of claim 15, wherein it is determined that a bid is to be submitted for the guaranteed delivery contract when a randomly selected number that is generated uniformly between 0.0 and 1.0 is less than a first bid parameter that corresponds to an adjustable probability value of submitting a bid for the guaranteed delivery contract.

17. The at least one computer readable storage medium of claim 15, wherein the bid amount is selected as a random number that is generated uniformly to be between zero and a second bid parameter that corresponds to a maximum value of the bid for the guaranteed delivery contract.

18. The at least one computer readable storage medium of claim 15, wherein it is determined that a bid is to be submitted for the guaranteed delivery contract when a randomly selected number is less than a first bid parameter, α, that corresponds to an adjustable probability value of submitting a bid and wherein the bid amount is selected as a random number that is less than a second bid parameter, p*, that corresponds to a maximum value of the bid, wherein the computer program instructions are further arranged to perform the following operation:
after each period k of a campaign duration that is divided into a plurality of periods N for such guaranteed delivery contract, adjusting the first and second bid parameters based on a current delivery after such each period, d(k), as compared to a delivery goal after such each period, g(k) and based on a running cost per impression (CPI) after such period as compared to a maximum average CPI for the campaign.

19. The at least one computer readable storage medium of claim 18, wherein:
the first parameter is increased and the second parameter is increased when the current delivery d(k) is less than the goal delivery g(k) and the running CPI is greater than the maximum CPI after such each period;
the first parameter and the second parameter are both decreased when the current delivery d(k) is greater than the goal delivery g(k) and the running CPI is greater than the maximum CPI after such each period;
the first parameter and the second parameter are both increased when the current delivery d(k) is less than the goal delivery g(k) and the running CPI is less than the maximum CPI after such each period; and
the first parameter is decreased and the second parameter is increased when the current delivery d(k) is greater than the goal delivery g(k) and the running CPI is less than the maximum CPI after such each period.

20. The at least one computer readable storage medium of claim 18, wherein the first and second parameters are limited by the following bounds:
$$α ( k + 1 ) = max ( min ( α ( k ) + β ( g ( k ) - d ( k ) ) , 1 ) , 0 )$$
$${p}^{*} ( k + 1 ) = min ( max ( {p}^{*} ( k ) - γ ( \frac{c ( k )}{d ( k )} - ρ ) , ρ ) , {\overline{ρ}}^{*} )$$
where c(k) is the cost incurred at the end of period k, d(k) is the current delivery at the end of period k, α(k) is the first parameter at the end of period k, p*(k) is the second parameter at the end of period k, β and γ are small positive numbers that represent the adaptation rates, and p̅* is the maximum value for p*.

21. The at least one computer readable storage medium of claim 20, wherein the second parameter is further adjusted according to:
$${p}^{*} ( k + 1 ) = min ( max ( {p}^{*} ( k ) - γ ( \frac{c ( k )}{d ( k )} - ρ ) - η ( g ( k ) - d ( k ) ) , ρ ) , {\overline{p}}^{*} )$$
where η is a small positive number.
